(19) United States
(12) Patent Application Publication
(10) Pub. No.: US 2005/0083264 A1
(43) Pub. Date: Apr. 21, 2005

(54) Method of driving flat-panel display (FPD) on which gray-scale data are efficiently displayed

(76) Inventor: Cheol-Hong Kim, Osan-si (KR)

Correspondence Address: MCGUIREWOODS, LLP, 1750 TYSONS BLVD, SUITE 1800, MCLEAN, VA, 22102, US

(21) Appl. No.: 10/942,782

(22) Filed: Sep. 17, 2004

(30) Foreign Application Priority Data
Oct. 15, 2003 (KR) 2003-71897

(51) Int. Cl. G09G 3/28

(52) U.S. Cl. 345/63

(57) ABSTRACT

A method of driving a flat-panel display, to which k bits of gray-scale data consisting of first through j-th bits, each having a low weighted value, and (j+1)-th through k-th bits, each having a high weighted value, are input during each frame. The method includes time-dividing a unit frame into a plurality of sub-fields, displaying the first through j-th bits (j is an integer greater than 2) of the gray-scale data by a plurality of frames and displaying the (j+1)-th through k-th bits (k is an integer greater than 4) of the gray scale data by the plurality of sub-fields.

This application claims the benefit of Korean Patent Application No. 2003-71897, filed on Oct. 15, 2003, which is hereby incorporated by reference for all purposes as if fully set forth herein.

### BACKGROUND OF THE INVENTION

1. Field of the Invention

The present invention relates to a method of driving a flat-panel display (FPD), and more particularly, to a FPD driving method in which a unit frame is time-divided into a plurality of sub-fields for performing time-division driving.

2. Discussion of the Related Art

FIG. 1 shows a structure of a conventional surface discharge plasma display panel, which is a FPD with a 3-electrode surface discharge structure. FIG. 2 shows an example of a display cell in the plasma display panel of FIG. 1. Referring to FIG. 1 and FIG. 2, address electrode lines A_{R1}, A_{G1}, . . . , A_{Gm}, A_{Bm}, dielectric layers 11 and 15, Y electrode lines Y₁, . . . , Yₙ, X electrode lines X₁, . . . , Xₙ, phosphors 16, partition walls 17, and an MgO protection layer 12 are formed between front and rear glass substrates 10 and 13 of the conventional surface discharge plasma display panel 1.

The address electrode lines A_{R1}, A_{G1}, . . . , A_{Gm}, A_{Bm}, which are covered by the lower dielectric layer 15, are formed in a predetermined pattern on an upper surface of the rear glass substrate 13. The partition walls 17, which create display cell discharge areas and help to prevent cross-talk between them, are formed on the surface of the lower dielectric layer 15, parallel to the address electrode lines A_{R1}, A_{G1}, . . . , A_{Gm}, A_{Bm}. The phosphors 16 are formed between each pair of adjacent partition walls 17.

Display electrode pairs, consisting of X electrode lines X₁, . . . , Xₙ, and Y electrode lines Y₁, . . . , Yₙ, are formed orthogonal to the address electrode lines A_{R1}, A_{G1}, . . . , A_{Gm}, A_{Bm}, on a lower surface of the front glass substrate 10, and each intersection forms a corresponding display cell. The X-electrode lines X₁, . . . , Xₙ and the Y-electrode lines Y₁, . . . , Yₙ have transparent electrode lines (Xₙₐ and Yₙₐ and of FIG. 2), composed of a transparent conductive material such as Indium Tin Oxide (ITO), and metal electrode lines (X_{nb} and Y_{nb} of FIG. 2) for enhancing conductivity. The upper dielectric layer 11 covers the X-electrode lines X₁, . . . , Xₙ and Y electrode lines Y₁, . . . , Yₙ. A protection layer 12, which protects the panel 1 in a strong electric field, is formed on the rear surface of the upper dielectric layer 11. The protection layer 12 may be formed of MgO. A discharge space 14 is filled with plasma-forming gas and sealed.

FIG. 3 is a view for explaining a conventional Address-Display Separation driving method for the plasma display panel of FIG. 1 (see U.S. Pat. No. 5,541,618). Referring to FIG. 3, unit frames are divided into 8 sub-fields SF1 through SF8 for time-division gray-scale display. Also, the sub-fields SF1 through SF8 are further divided into resetting times R1 through R8, addressing times A1 through A8, and discharge sustain periods S1 through S8.

The resetting times R1 through R8 are required to uniformly distribute electric charges in all display cells.

During respective addressing times A1 through A8, corresponding scanning pulses are sequentially transmitted to the respective Y electrode lines Y₁, . . . , Yₙ, while a display data signal is transmitted to the respective address electrode lines (A_{R1}, . . . , A_{Bm} of FIG. 1). Accordingly, if a high level display data signal is transmitted while the scanning pulses are transmitted, addressing discharges form wall charges in selected discharge cells and wall charges are not formed in non-selected discharge cells.

During the respective discharge sustain periods S1 through S8, discharge sustain pulses are alternately transmitted to all the Y electrode lines Y₁, . . . , Yₙ and all the X electrode lines X₁, . . . , Xₙ, thus generating display discharge in selected discharge cells. Accordingly, plasma display panel brightness is proportional to the total lengths of the discharge-sustain times S1 through S8 of a unit frame. The total lengths of the discharge-sustain times S1 through S8 of a unit frame is 255 T (T is a unit-time). Hence, 257 gray-scales, including a zero (0) gray-scale, may be displayed by a unit frame.

Here, a period of 1 T, corresponding to 2⁰, is allocated to a discharge-sustain time S1 of a first sub-field SF1, a period of 2 T, corresponding to 2¹, is allocated to a discharge-sustain time S2 of a second sub-field SF2, a period of 4 T, corresponding to 2², is allocated to a discharge-sustain time S3 of a third sub-field SF3, a period of 8 T, corresponding to 2³, is allocated to a discharge-sustain time S4 of a fourth sub-field SF4, a period of 16 T, corresponding to 2⁴, is allocated to a discharge-sustain time S5 of a fifth sub-field SF5, a period of 32 T, corresponding to 2⁵, is allocated to a discharge-sustain time S6 of a sixth sub-field SF6, a period of 64 T, corresponding to 2⁶, is allocated to a discharge-sustain time S7 of a seventh sub-field SF7, and a period of 128 T, corresponding to 2⁷, is allocated to a discharge-sustain time S8 of an eighth sub-field SF8.

Accordingly, by appropriately selecting sub-fields SF1 through SF8 to be displayed, a total of 256 gray-scales, including a zero (0) gray-scale (not displayed on any sub-field), may be displayed.

In a FPD driving method used for such time-division driving, as the number of bits of input gray-scale data increases, the number of sub-fields of a unit frame must also increase. However, the number of sub-fields of a unit frame cannot be increased because of the limited time per unit frame (for example, 1/60 second in case of a NTSC type image signal and 1/50 second in case of a PAL type image signal).

Additionally, since plasma display panel initialization times, such as the resetting times R1 through R8 of FIG. 3, increase proportionally to the number of sub-fields, image contrast would deteriorate with increased numbers of sub-fields.

### SUMMARY OF THE INVENTION

The present invention provides a flat-panel display (FPD) driving method, in which a unit frame is time-divided into a plurality of sub-fields and time-division driving is performed, wherein more gray-scales may be displayed using a limited number of sub-fields.

Additional features of the invention will be set forth in the description which follows, and in part will be apparent from the description, or may be learned by practice of the invention.

The present invention discloses a method of driving a flat-panel display, to which k bits of gray-scale data consisting of first through j-th bits, each having a low weighted value, and (j+1)-th through k-th bits, each having a high weighted value, is input per each frame, the method comprising the steps of time-dividing a unit frame into a plurality of sub-fields; displaying the first through j-th bits (j is an integer greater than 2) of the gray-scale data by a plurality of frames and displaying the (j+1)-th through k-th bits (k is an integer greater than 4) of the gray-scale data by the plurality of sub-fields.

The present invention also discloses a method of driving a flat panel display, comprising time dividing a unit frame into a plurality of subfields, inputting first through j-th bits of gray scale data per unit frame, and inputting (j+1)-th through k bits of gray scale data per unit frame. The first through j-th bits of gray scale data are displayed by at least one subfield of at least two frames, and the (j+1)-th through k bits of gray scale data are displayed in a single frame. J is an integer having a value of 3 or more, and k is an integer having a value of 5 or more.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a conventional surface discharge plasma display panel with a 3-electrode surface discharge structure.

FIG. 2 shows a display cell of the plasma display panel of FIG. 1.

FIG. 3 shows a timing diagram of a conventional Address-Display Separation driving method of the plasma display panel of FIG. 1.

FIG. 4 shows a driving apparatus for performing a driving method according to an exemplary embodiment of the present invention.

FIG. 5 shows a timing diagram of a driving method in which gray-scale data of (j+1)-th through k-th bits (j is an integer greater than 2 and k is an integer greater than 4) is displayed by a plurality of sub-fields of a unit frame according to an exemplary embodiment of the present invention.

FIG. 6, FIG. 7, FIG. 8, FIG. 9, FIG. 10, FIG. 11 and FIG. 12 show timing diagrams of a driving method in which gray-scale data of first through j-th bits (j is an integer greater than 2) is displayed by a plurality of frames according to an exemplary embodiment of the present invention.

### DETAILED DESCRIPTION OF THE INVENTION

Hereinafter, exemplary embodiments of the present invention will be described in detail with reference to the appended drawings.

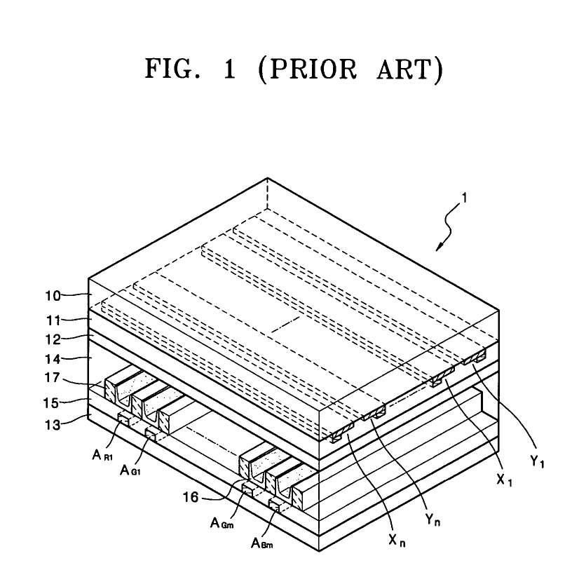

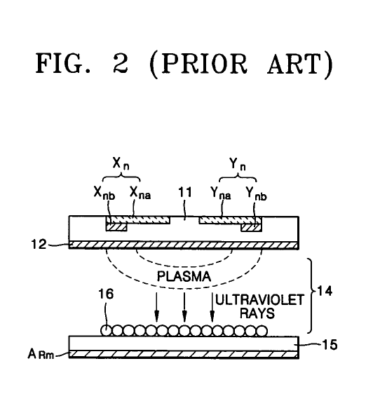

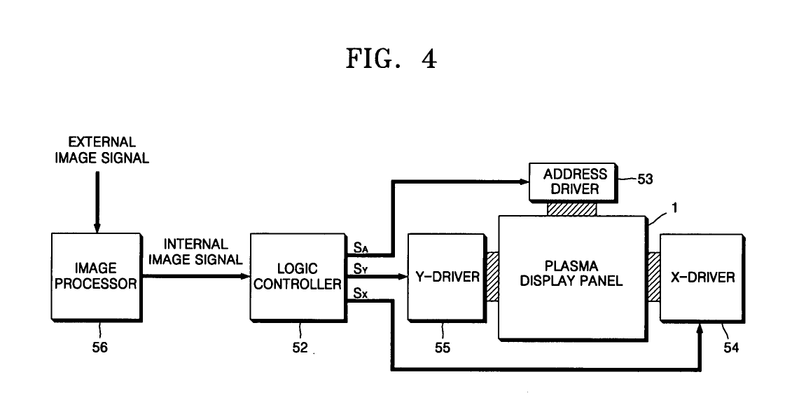

FIG. 4 is a block diagram of a driving apparatus, which performs a driving method according to an exemplary embodiment of the present invention, of a plasma display panel of FIG. 1.

Referring to FIG. 4, the driving apparatus comprises an image processor 56, a logic controller 52, an address driver 53, a X driver 54, and a Y driver 55. The image processor 56 converts external image signals into digital signals and generates digital image signals, such as 8 bit red (R), green (G), and blue (B) image data, clock signals, and vertical and horizontal synchronization signals. The logic controller 52, which controls a driving method according to an exemplary embodiment of the present invention, generates driving control signals S_{A}, S_{Y}, and S_{X} in response to the internal image signals received from the image processor 56. The address driver 53 receives and processes the address signal S_{A}, generates a display data signal, and transmits that signal to address electrode lines. The X driver 64 receives and processes the X driving control signal S_{X} and transmits it to X electrode lines. The Y driver 55 receives and processes the Y driving control signal S_{Y} and transmits it to Y electrode lines.

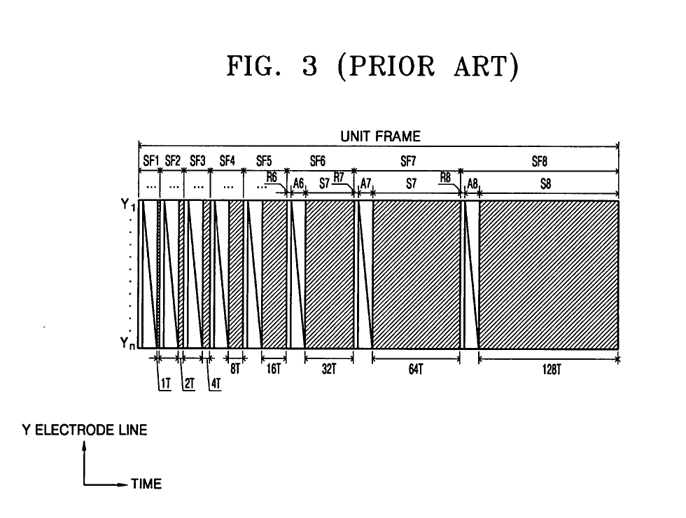

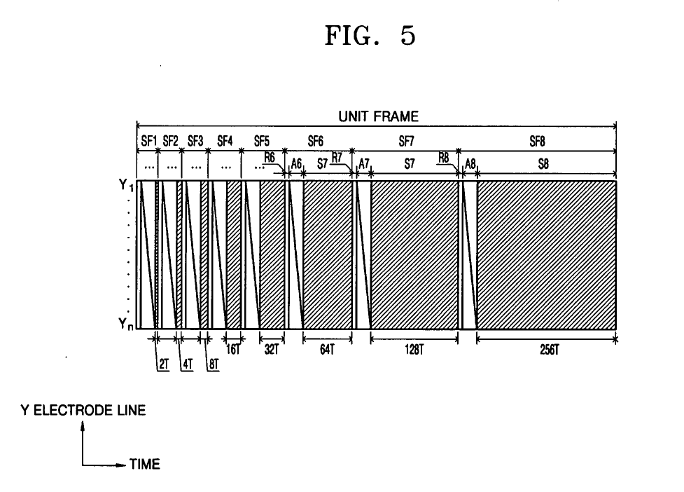

FIG. 5 illustrates a driving method of an exemplary embodiment of the present invention by which upper bit gray-scale data of (j+1)-th through k-th bits, (j is an integer greater than 2 and k is an integer greater than 4), is displayed using a plurality of sub-fields (SF1 through SF8) of a unit frame. In FIG. 5, the same reference numbers of those of FIG. 3 indicate objects with same functions as the respective components of FIG. 3 Hereinafter, a difference between the driving method of FIG. 3 and the driving method of FIG. 5 will be described.

Referring to FIG. 5, a discharge sustain period S1 of a first sub-field SF1 is set to 2 T. A discharge sustain period S2 of a second sub-field SF2 is set to 4 T. A discharge sustain period S3 of a third sub-field SF3 is set to 8 T. A discharge sustain period S4 of a fourth sub-field SF4 is set to 16 T. A discharge sustain period S5 of a fifth sub-field SF5 is set to 32 T. A discharge sustain period S6 of a sixth sub-field SF6 is set to 64 T. A discharge sustain period S7 of a seventh sub-field SF7 is set to 128 T. A discharge sustain period S8 of an eighth sub-field SF8 is set to 256 T.

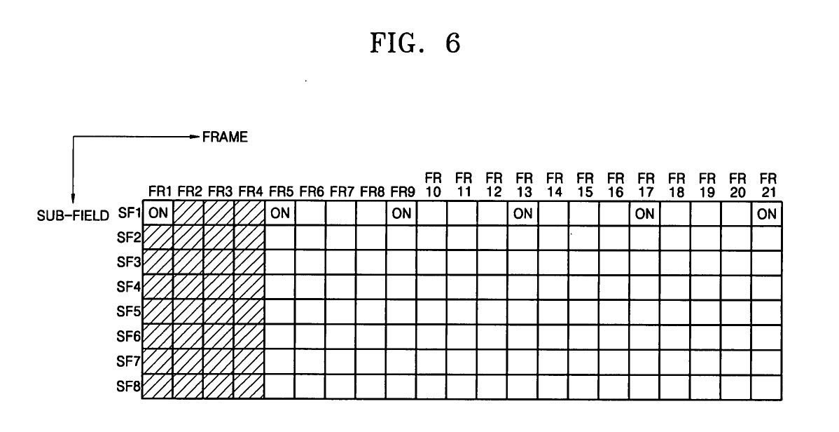

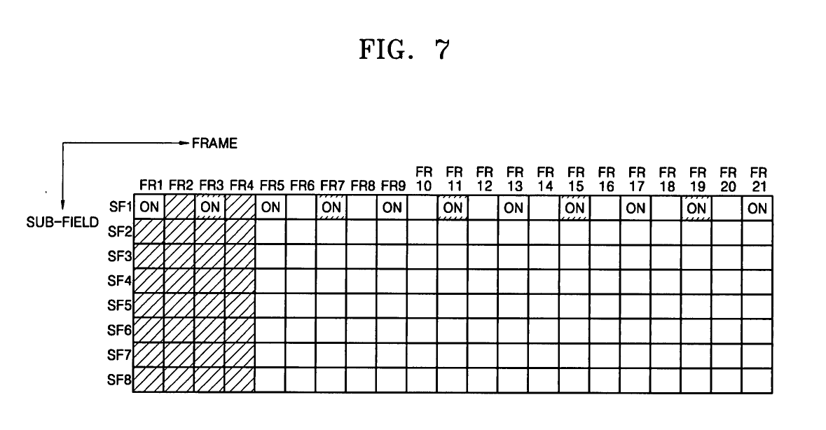

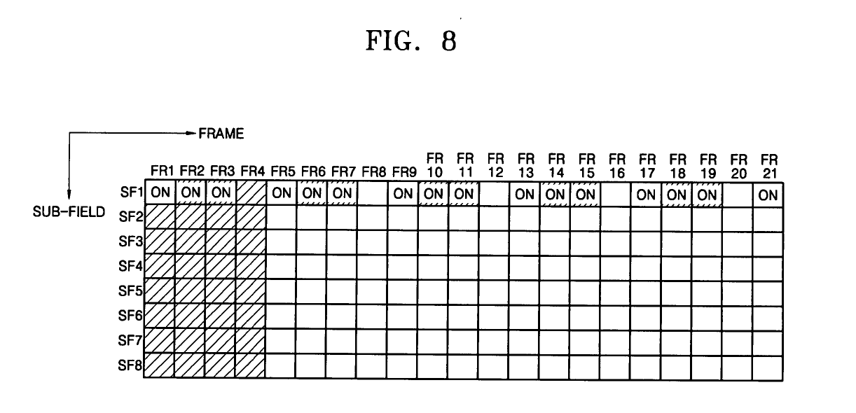

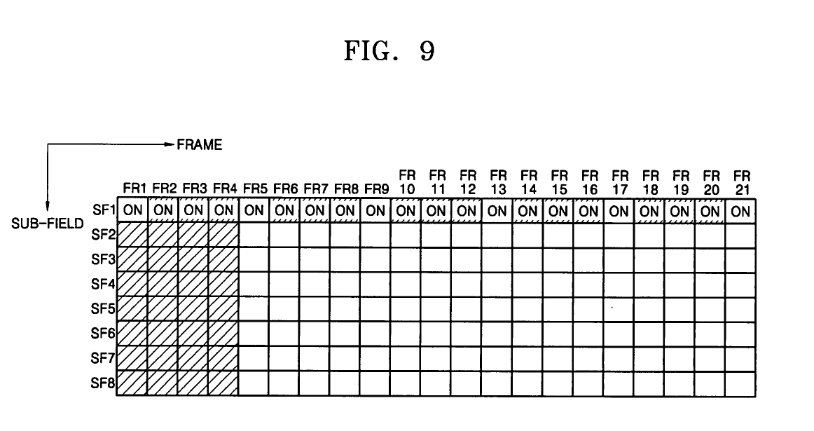

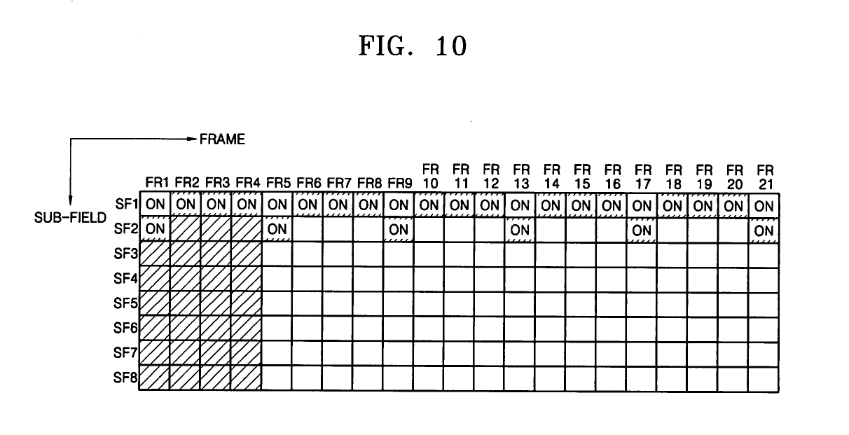

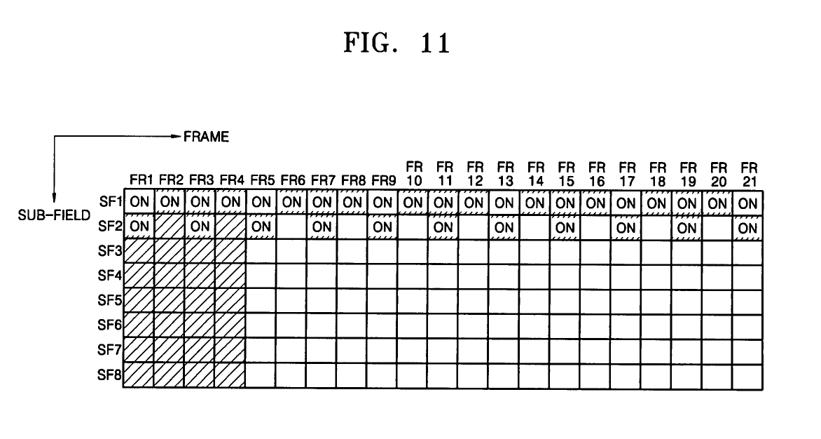

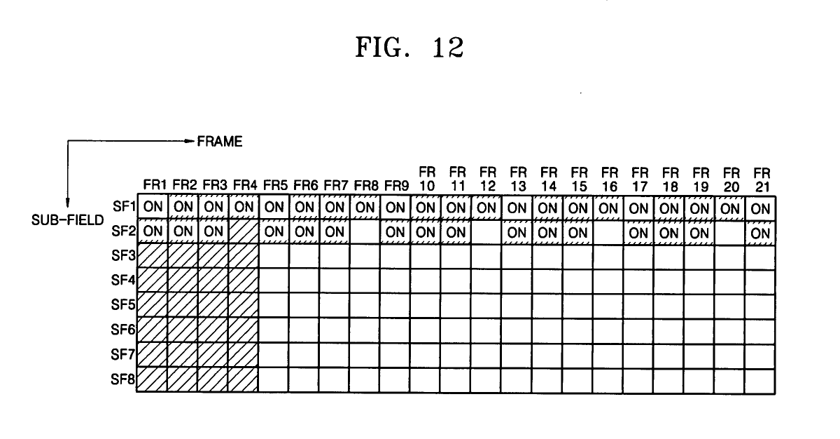

The discharge sustain periods are set longer in an exemplary embodiment of the present invention than conventionally because low gray-scale data having periods less than 1 T, which corresponds to gray-scale data of first through j-th bits (j is an integer greater than 2 ), may be displayed by a plurality of frames. This will now be described in detail with reference to FIG. 6, FIG. 7, FIG. 8, FIG. 9, FIG. 10, FIG. 11 and FIG. 12.

Timing diagrams in FIGS. 6 through 12 illustrate a driving method according to an exemplary embodiment of the present invention in which low gray-scale data of the first through j-th bits (j is an integer greater than 2) is displayed by the respective first and second sub-fields SF1 and SF2 of four frames.

FIG. 6 is a timing diagram illustrating a driving method of an exemplary embodiment of the present invention in which gray-scale data of the first through j-th bits (j is an integer greater than 2) corresponding to T/8 (T is a unit time) are displayed during the respective first and second sub-fields SF1 and SF2 of four frames. For example, if low gray-scale data corresponding to T/8 in a first frame FR1 is input to a display cell, the display cell emits lights only during a first sub-field SF1 of the first frame FR1. Likewise, if other gray-scale data in second through fourth frames FR2 through FR4 is input to the display cell, the display cell will emit light during selected sub-fields of the second through fourth frames FR2 through FR4. However, in the first through fourth frames FR1 through FR4, low gray-scale data corresponding to T/8 of the first frame FR1 may be displayed.

FIG. 7 is a timing diagram illustrating a driving method of an exemplary embodiment of the present invention in which the first through j-th bits (j is an integer greater than 2) of gray scale data corresponding to 2 T/8 (T is a unit time) are displayed during the respective first and second sub-fields SF1 and SF2 of four frames. For example, if low gray-scale data corresponding to 2 T/8 in the first frame FR1 is input to a display cell, the display cell is displayed only in a first sub-field SF1 of the first frame FR1 and a first sub-field SF1 of a third frame FR3. Likewise, if another gray-scale data in the second through fourth frames FR2 through FR4 is input to the display cell, the display cell will emit light during selected sub-fields of the second through fourth frames FR2 through FR4. However, in the first through fourth frames FR1 through FR4, low gray-scale data corresponding to a 2 T/8 gray-scale of the first frame FR1 may be displayed.

FIG. 8 is a timing diagram illustrating a driving method of an exemplary embodiment of the present invention in which the first through j-th bits (j is an integer greater than 2) of gray scale data corresponding to 3 T/8 (T is a unit time of FIG. 5) are displayed during the respective first and second sub-fields SF1 and SF2 of four frames. For example, if low gray-scale data corresponding to 3 T/8 in the first frame FR1 is input to a display cell, the display cell emits light only in the first sub-fields SF1 of the first through third frames FR1 through FR3. Likewise, if other gray-scale data in the second through fourth frames FR2 through FR4 is input to the display cell, the display cell will emit light during selected sub-fields of the second through fourth frames FR2 through FR4. However, in the first through fourth frames FR1 through FR4, low gray-scale data corresponding to a 3 T/8 gray-scale of the first frame FR1 may be displayed.

FIG. 9 is a timing diagram illustrating a driving method of an exemplary embodiment of the present invention in which the first through j-th bits (j is an integer greater than 2) of gray scale data corresponding to 4 T/8 (T is a unit time of FIG. 5) are displayed during the respective first and second sub-fields SF1 and SF2 of four frames. For example, if low gray-scale data corresponding to 4 T/8 in the first frame FR1 is input to a display cell, the display cell emits light only in the first sub-fields SF1 of the first through fourth frames FR1 through FR4. Likewise, if other gray-scale data in the second through fourth frames FR2 through FR4 is input to the display cell, the display cell will emit light during selected sub-fields of the second through fourth frames FR2 through FR4. However, in the first through fourth frames FR1 through FR4, low gray-scale data corresponding to a 4 T/8 gray-scale of the first frame FR1 may be displayed

FIG. 10 is a timing diagram illustrating a driving method of an exemplary embodiment of the present invention in which 5 T/8 gray-scales (T is a unit time) as gray-scale data of the first through j-th bits (j is an integer greater than 2) are displayed by the respective first and second sub-fields SF1 and SF2 of four frames. For example, if low gray-scale data corresponding to a 5 T/8 gray-scale in the first frame FR1 is input to a display cell, the display cell is displayed only in the first sub-fields SF1 of the first through fourth frames FR1 through FR4 and the second sub-field SF2 of the first frame FR1. Likewise, if another gray-scale data in the second through fourth frames FR2 through FR4 is input to the display cell, the display cell is displayed in selected sub-fields of the second through fourth frames FR2 through FR4. However, in the first through fourth frames FR1 through FR4, low gray-scale data corresponding to a 5 T/8 gray-scale of the first frame FR1 may be displayed.

FIG. 11 is a timing diagram illustrating a driving method of an exemplary embodiment of the present invention in which 6 T/8 gray-scales (T is a unit time of FIG. 5) as gray-scale data of the first through j-th bits (j is an integer greater than 2) are displayed by the respective first and second sub-fields SF1 and SF2 of four frames. For example, if low gray-scale data corresponding to a 6 T/8 gray-scale in the first frame FR1 is input to a display cell, the display cell is displayed only in the first sub-fields SF1 of the first through fourth frames FR1 through FR4, the second sub-field SF2 of the first frame FR1, and the second sub-field SF2 of the third frame FR3. Likewise, if another gray-scale data in the second through fourth frames FR2 through FR4 is input to the display cell, the display cell is displayed in selected sub-fields of the second through fourth frames FR2 through FR4. However, in the first through fourth frames FR1 through FR4, low gray-scale data corresponding to a 6 T/8 gray-scale of the first frame FR1 may be displayed.

FIG. 12 is a timing diagram illustrating a driving method of an exemplary embodiment of the present invention in which the first through j-th bits (j is an integer greater than 2) of gray scale data corresponding to 7 T/8 (T is a unit time) are displayed by the respective first and second sub-fields SF1 and SF2 of four frames. For example, if low gray-scale data corresponding to a 7 T/8 gray-scale in the first frame FR1 is input to a display cell, the display cell is displayed only in the first sub-fields SF1 of the first through fourth frames FR1 through FR4 and the second sub-fields SF2 of the first through third frames FR1 through FR3. Likewise, if another gray-scale data in the second through fourth frame FR2 through FR4 is input to the display cell, the display cell is displayed in selected sub-fields of the second through fourth frames FR2 through FR4. However, in the first through fourth frames FR1 through FR4, low gray-scale data corresponding to a 7 T/8 gray-scale of the first frame FR1 may be displayed.

As described above, according to a FPD driving method of an exemplary embodiment of the present invention, first through j-th bits (j is an integer greater than 2) of gray-scale data may be displayed by a plurality of frames. Accordingly, the number of sub-fields of a unit frame may only be set to (j+1)-th through k-th bits (k is an integer greater than 4) of gray-scale data. Therefore, it is possible to display more gray-scales using a limited number of sub-fields.

An exemplary embodiment of the present invention describes four frames used to display the low gray-scale data of the first through j-th bits. However, the present invention is not limited as such and other than four frames may be used to display the low gray-scale data of the first through j-th bits.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of driving a flat-panel display, to which k bits of gray-scale data consisting of first through j-th bits, each having a low weighted value, and (j+1)-th through k-th bits, each having a high weighted value, is input per each frame, comprising:
time-dividing a unit frame into a plurality of sub-fields;
displaying first through j-th bits of gray-scale data by a plurality of frames; and
displaying (j+1)-th through k-th bits of the gray-scale data by the plurality of sub-fields;
wherein j is an integer greater than 2, and
wherein k is an integer greater than 4.

2. The method of claim 1, wherein, when displaying the first through j-th bits of the gray-scale data by the plurality of frames, at least a sub-field of each of the plurality of frames is used.

3. The method of claim 2, wherein,
when time dividing the unit frame into the plurality of sub-fields, the unit frame is time-divided into first through p-th sub-fields having a low weighted value, and (p+1)-th through q-th sub-fields having a high weighted value, and
when displaying the first through j-th bits of the gray-scale data by the plurality of frames, at least one sub-field of the first through p-th sub-fields is used in each of the frames,
wherein p is an integer greater than 2, and
wherein q is an integer greater than 4.

4. A method of driving a flat panel display, comprising:
time dividing a unit frame into a plurality of subfields;
inputting first through j-th bits of gray scale data per unit frame;
inputting (j+1)-th through k bits of gray scale data per unit frame;
displaying the first through j-th bits of gray scale data by at least one subfield of at least two frames; and
displaying the (j+1)-th through k bits of gray scale data in a single frame;
wherein j is an integer having a value of 3 or more,
wherein k is an integer having a value of 5 or more.
